(19) United States
(12) Patent Application Publication
(10) Pub. No.: US 2003/0052749 A1
(43) Pub. Date: Mar. 20, 2003

(54) Resonator, method for manufacturing filter by using resonator and filter manufactured by the same method

(76) Inventors: In Kui Cho, Taejon (KR); Jin Tae Kim, Seoul (KR); Myung Yung Jeong, Taejon (KR); Tae Goo Choy, Taejon (KR)

Correspondence Address: JACOBSON HOLMAN, PLLC., PROFESSIONAL LIMITED LIABILITY COMPANY, 400 Seventh Street, N.W., Washington, DC, 20004, US

(21) Appl. No.: 09/998,204

(22) Filed: Dec. 3, 2001

(30) Foreign Application Priority Data
Sep. 4, 2001 (KR) 2001-54130

(51) Int. Cl. H01P 1/202; H01P 7/04

(52) U.S. Cl. 333/202; 333/222

(57) ABSTRACT

There are provided a resonator for use in a filter, which interprets and reduces intermodulation distortion by analyzing characteristics of current density occurring at resonance and linear and nonlinear characteristics of the filter, a method for manufacturing filters by using the resonator and a filter manufactured by the method. The resonator has a ratio of an inside diameter to an outside diameter belonging to a range which is larger than about 1:3 and smaller than or equal to about 1:3.75 and its length (H) is about λ/4, wherein λ is a wavelength of a plane wave provided to the resonator. By employing the method, it is possible to effectively design the filters through the use of a circuitry and structural approach with breaking from a conventional approach depending on local and minute processing steps when manufacturing the filters.

### FIELD OF THE INVENTION

The present invention relates to a resonator and techniques using the same; and, more particularly, to a resonator for use in a filter capable of interpreting and reducing intermodulation distortion by analyzing characteristics of current density occurring at resonance and linear and nonlinear characteristics of the filter, a method for manufacturing a filter by using resonators and a filter manufactured by the method.

### BACKGROUND OF THE INVENTION

In general, intermodulation distortion is caused by nonlinear transfer characteristics of electronic devices and means a phenomenon in which there are found frequency components of sum and difference of input signals at an output signal of the electronic device. The intermodulation distortion becomes a major cause raising interference in extending the capacity of communication systems and improving the speech quality.

In the past, it had been known that the intermodulation distortion was generated only in active elements.

However, now, the intermodulation distortion is found in passive radio frequency (RF) elements regarded as having linear transfer characteristics. Although a level of the passive intermodulation distortion is lower than that caused in the active elements, researches for reducing the intermodulation distortion are performed in a direction of removing factors inducing the intermodulation distortion since a filtering technique used in the active elements is not applicable to the passive RF elements.

In order to extend the communication capacity of mobile communication systems and improve the speech quality thereof, a technique for controlling the intermodulation distortion of the passive elements is essentially required. In particular, a filter is a passive element in which the dominant intermodulation distortion is caused and a technique for controlling the filter has various obstacles timely and economically since there are diversity and complexity in causing the intermodulation distortion in the filter.

According to the conventional researches, to reduce the intermodulation distortion generated in the passive RF elements and the filters, the researches have focused on a plating process, a housing, an input/output connector, etc. with local and minute processing steps instead of employing a circuitry approach considering designing steps.

The reason why the conventional research directions are determined as above is that the causes raising the passive intermodulation distortion are classified into contact nonlinearity and material nonlinearity and the researches have been carried out in analyzing and eliminating the intermodulation distortion due to, especially, materials having ferromagnetism or metal-to-metal bonding.

As a result, the researches have made advances in the analysis and elimination of the intermodulation distortion caused by the contact and the ferromagnetic problems.

However, employing welding or soldering so as to reduce nonlinearity induced by the metal-to-metal bonding in the housing of the filter has a problem of making assembly and disassembly difficult.

In order to solve the above problem, there have been introduced techniques described in U.S. Pat. Nos. 5,834,993 and 5,304,962, entitled “PASSIVE MICROWAVE STRUCTURE AND METHODS HAVING REDUCED PASSIVE INTERMODULATION” and “MICROWAVE TRANSMISSION MEANS WITH IMPROVED COATINGS”, respectively.

The U.S. Pat. No. 5,834,993 employed a bucking scheme so as to overcome the above drawbacks, resulting in introducing convenient processing steps and shortening an assembly time.

Further, there is a problem that conductive loss occurs by conductivity limited on a coaxial cable when transmitting signals through the coaxial cable and this conductive loss is conducted as heat, which causes new intermodulation distortion.

To overcome this problem, there has been introduced a technique illustrated in U.S. Pat. No. 5,304,962, entitled “MICROWAVE TRANSMISSION MEANS WITH IMPROVED COATINGS”.

This patented application provides a filter incorporated in a duplex base station cellular telephony transmit/receive system, which has aluminum parts having plated thereon a composite coating which is entirely of nonferromagnetic materials to reduce creation in the filter of intermodulation products and which consists of a zinc layer on an aluminum substrate and copper and silver layers outward in that order from the zinc layer and having respective thickness of at least about 300 microinches, and of at least about 500 microinches to reduce resistance losses incurred by microwaves traveling throughout the filter.

Since, however, the conventional techniques have focused on the plating process, the housing, the input/output connector, etc. with local and minute processing steps instead of adopting the circuitry approach considering designing steps, there are required good processing techniques, a clean processing environment and technical locality and the conventional techniques could not help depending on proficiency of manufacturers.

### SUMMARY OF THE INVENTION

It is, therefore, a primary object of the present invention to provide a resonator for use in a mobile communication base station system capable of effectively contributing to increase of communication capacity and quality improvement by trying out a structural approach on a circuitry design for reduction of intermodulation distortion caused in a filter and, thus, reducing interference of a mobile communication system.

Another object of the present invention is to provide a filter manufacturing method capable of effectively contributing to increase of communication capacity and quality improvement by reducing interference of a mobile communication system through the use of the inventive resonator and a filter manufactured by the filter manufacturing method.

In accordance with one aspect of the present invention, there is provided a resonator for use in a filter so as to reduce intermodulation distortion, which has a ratio of an inside diameter to an outside diameter belonging to a range that is larger than about 1:3 and smaller than or equal to about 1:3.75 and whose length (H) is about λ/4, wherein λ is a wavelength of a plane wave provided to the resonator.

In accordance with another aspect of the present invention, there is provided a method for manufacturing a resonator filter so as to minimize the current flowing through each resonator constructing the filter made of several resonators, wherein characteristic impedance of an equivalent circuit of the resonator filter has a value in a range which is larger than about 65 Ω and smaller than or equal to about 79 Ω.

### BRIEF DESCRIPTION OF THE DRAWINGS

The above and other objects and features of the present invention will become apparent from the following description of preferred embodiments given in conjunction with the accompanying drawings, in which:

FIG. 1 is a view illustrating a configuration of a λ/4 short coaxial cavity resonator in accordance with the present invention;

FIG. 2 is a view showing electric and magnetic fields inside the resonator in FIG. 1;

FIG. 3 is a view describing a lumped constant equivalent circuit of a communication high frequency filter in accordance with the present invention;

FIG. 4 represents a graph describing amplitudes of current flowing through an output load of 50 Ω and each resonator according to a varying frequency when designing each resonator for use in an inventive filter to have an inside diameter of 10 mm and an outside diameter of 20 mm in accordance with an embodiment of the present invention;

FIG. 5 shows a graph illustrating amplitudes of current flowing through an output load of 50 Ω and each resonator according to a varying frequency when designing each resonator for use in an inventive filter to have an inside diameter of 10 mm and an outside diameter of 30 mm in accordance with an embodiment of the present invention;

FIG. 6 provides a graph describing amplitudes of current flowing through an output load of 50 Ω and each resonator according to a varying frequency when designing each resonator for use in an inventive filter to have an inside diameter of 10 mm and an outside diameter of 40 mm in accordance with an embodiment of the present invention;

FIG. 7 is a graph showing levels of final intermodulation distortion for an outside diameter of a resonator in accordance with the present invention;

FIG. 8A shows a graph representing variation of the amplitude of initial intermodulation distortion and that of ascending intermodulation distortion in accordance with an embodiment of the present invention;

FIG. 8B provides a graph displaying levels of final intermodulation distortion determined by adjusting an inside diameter in accordance with the present invention;

FIG. 9A depicts a graph describing an intermodulation distortion characteristic when deciding a ripple in a pass band as 0.1 dB;

FIG. 9B presents a graph showing a voltage size detected at each resonator in case of FIG. 9A;

FIG. 9C is a graph illustrating an intermodulation distortion characteristic when determining a ripple in a pass band as 0.001 dB;

FIG. 9D describes a graph displaying a voltage size detected at each resonator in case of FIG. 9C;

FIG. 10 is a table of showing the equivalent circuit constants R, L, C and Cc of a J inverter according to the various outside diameters of the resonator mentioned in FIG. 1; and

FIG. 11 is a table of showing levels of intermodulation distortion according to an amount of current of each resonator in filter structures obtained from FIGS. 4 to 6.

### DETAILED DESCRIPTION OF THE PREFERRED EMBODIMENTS

Hereinafter, with reference to the accompanying drawings, a preferred embodiment of the present invention will be explained in detail.

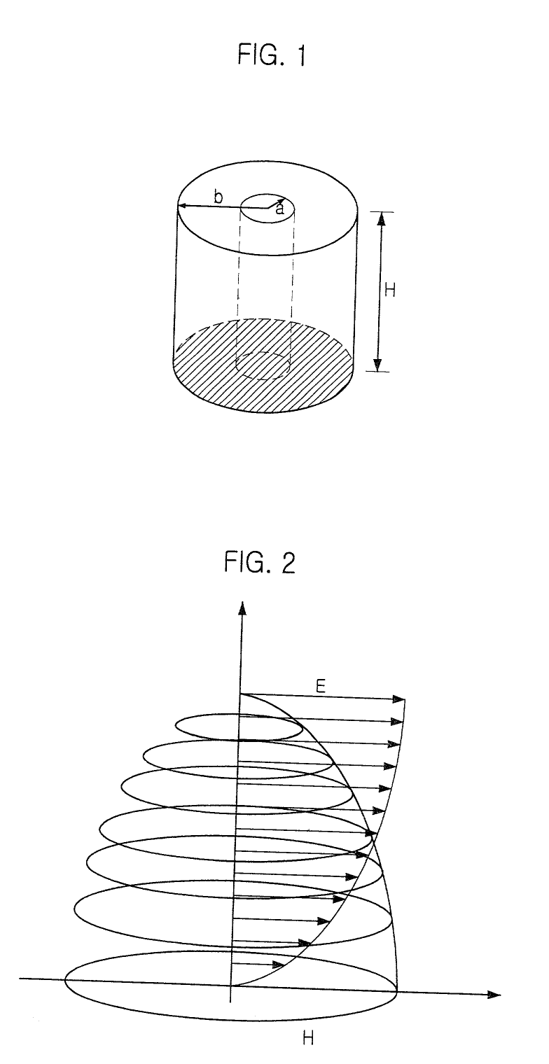

Referring to FIG. 1, there is provided a view illustrating a configuration of a λ/4 short coaxial cavity resonator for use in a filter in accordance with the present invention.

In FIG. 1, there are shown an inside diameter a and an outside diameter b of a conductor of the resonator. Therefore, there dominantly exists a transverse electromagnetic (TEM) mode in a field.

Referring to FIG. 2, there is provided a view showing electric (E) and magnetic (H) fields inside the resonator in FIG. 1.

A lumped constant equivalent circuit of the resonator can be described as a parallel form of resistors (R), inductors (L) and capacitors (C). Equivalent circuit constants can be represented as shown in equations EQ. 1 and EQ. 2.

$$\begin{matrix}R = {Y}_{0} {a}_{t} λ = \frac{( 2 n - 1 )}{4} {Y}_{0} {a}_{t} {λ}_{g 0} & EQ . 1 \\ ϕ = {ω}_{0} C = \frac{1}{{ω}_{0} L} = \frac{( 2 n - 1 )}{4} π {{Y}_{0} ( \frac{{λ}_{g 0}}{{λ}_{0}} )}^{2} & EQ . 2\end{matrix}$$

Herein, an inside wavelength of a tube λ_{g0} is 2π/β and a wavelength of a plane wave λ₀ is 2π/k. In case of a coaxial cable, since transmission is carried out in the TEM mode, β becomes identical to k.

Now, equivalent circuit constants and a characteristic admittance of a coaxial transmission line are determined as shown herein below. Here, it is assumed that there is no loss in all media.

When deciding the inside diameter a and the outside diameter b of the resonator as 10 mm and 20 mm, respectively, its lumped constant equivalent circuit values and a length of the resonator can be expressed as shown in following equations EQ. 3 to EQ. 10 in case a frequency is 1 GHz.

$$H = \frac{λ}{4} = \frac{c}{4 f} = 0.075 m = 75 mm \qquad EQ . 3$$

Herein, H means the length of the resonator.

$${Z}_{0} = \frac{60}{\sqrt{ϵ r}} ln \frac{b}{a} = 41.58883 Ω \qquad EQ . 4$$

$$\begin{matrix}{Y}_{0} = \frac{1}{{Z}_{0}} = 0.0240449 mho & EQ . 5 \\ L = \frac{4}{π {Y}_{0} {ω}_{0}} = 8.42765 nH & EQ . 6 \\ C = \frac{π {Y}_{0}}{4 {ω}_{0}} = 3.00561 pF & EQ . 7 \\ {R}_{s} = \sqrt{\frac{{ωμ}_{0}}{2 σ}} = 8.241 m Ω & EQ . 8 \\ {α}_{c} = \frac{{R}_{s}}{2 ηln \frac{b}{a}} ( \frac{1}{a} + \frac{1}{b} ) = 0.0023652537 Np \text{/} m & EQ . 9 \\ R = \frac{{Z}_{0}}{{α}_{c} H} = 234.445 k Ω & EQ . 10\end{matrix}$$

In the same manner as described above, when setting the inside diameter a and the outside diameter b of the resonator to 10 mm and 30 mm, respectively, H, Z₀, L, C and R are determined as 75 mm, 65.9167 Ω, 13.3575 nH, 1.89633 pF and 662.569 kΩ, respectively.

Furthermore, when deciding the inside diameter a and the outside diameter b of the resonator as 10 mm and 40 mm, respectively, H, Z₀, L, C and R are determined as 75 mm, 83.1776 Ω, 16.855318 nH, 1.50280725 pF and 1125.33544 kΩ, respectively.

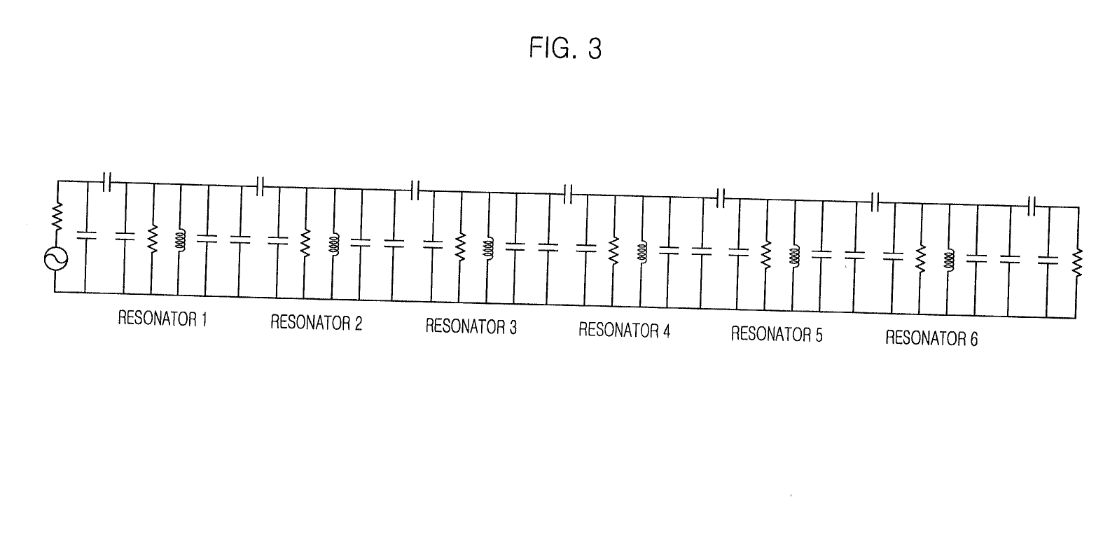

Referring to FIG. 3, there is illustrated a view describing a lumped constant equivalent circuit of a communication high frequency filter in accordance with the present invention, which represents a 6 dimensional inverter type filter.

Resonators are connected to each other through a J inverter and its design specification is as follows. A mean frequency is 1 GHz; a bandwidth is 10 MHz; its dimension is 6; input/output impedance is 50 Ω; a ripple is 0.2 dB; and its filter type is decided as Chebyshev.

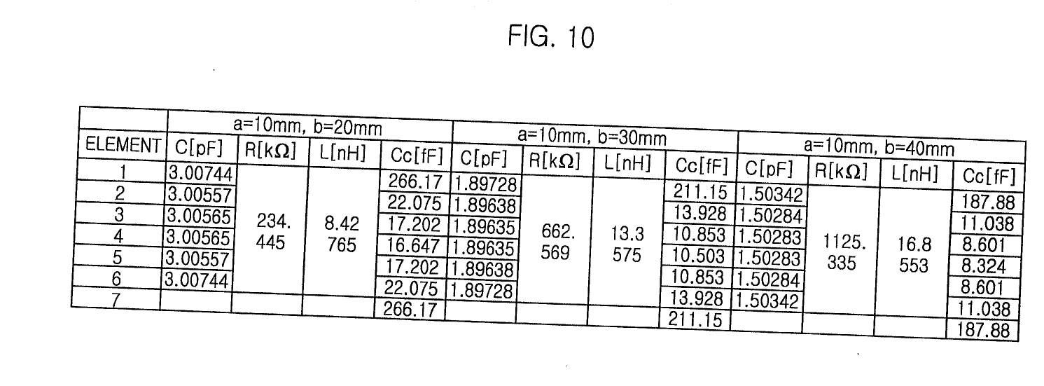

There are shown in FIG. 10 the equivalent circuit constants R, L, C and Cc of the J inverter according to the various outside diameters of the resonator mentioned in FIG. 1.

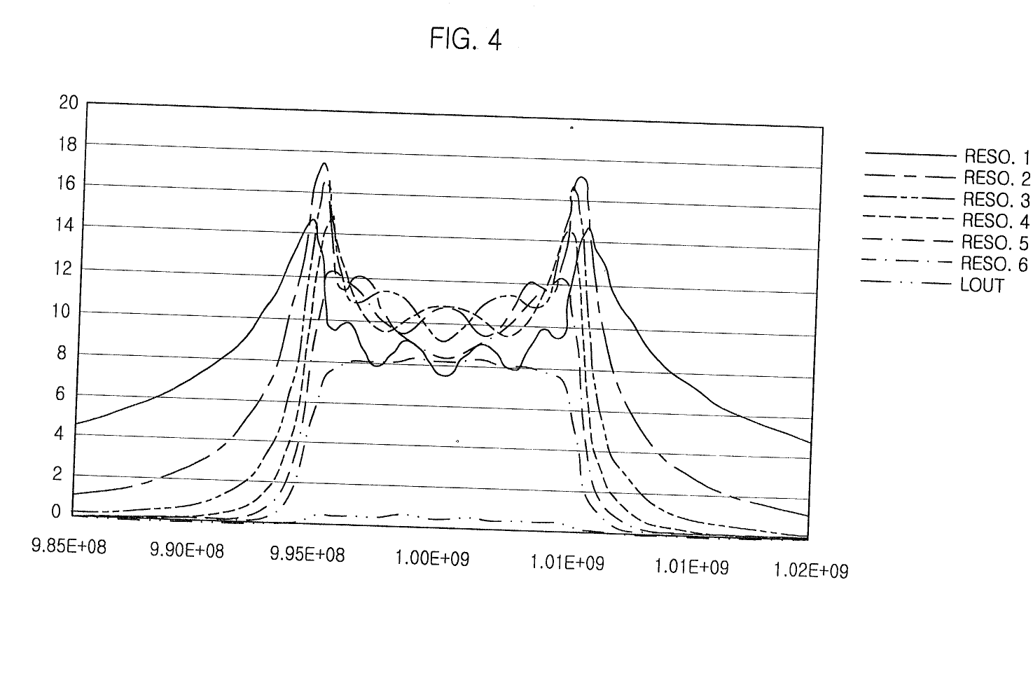

Referring to FIG. 4, there is represented a graph describing amplitudes of current flowing through an output load of 50 Ω and each resonator according to a varying frequency when designing each resonator for use in the inventive filter to have an inside diameter of 10 mm and an outside diameter of 20 mm in accordance with an embodiment of the present invention.

The peak current values of the first to the fifth resonators are found at the cut-off frequency of the filter and the sixth resonator shows a current characteristic similar to that of the filter. As shown in FIG. 4, it is noticed that a resonator having the highest current value is the second resonator and the third resonator has the second highest current value.

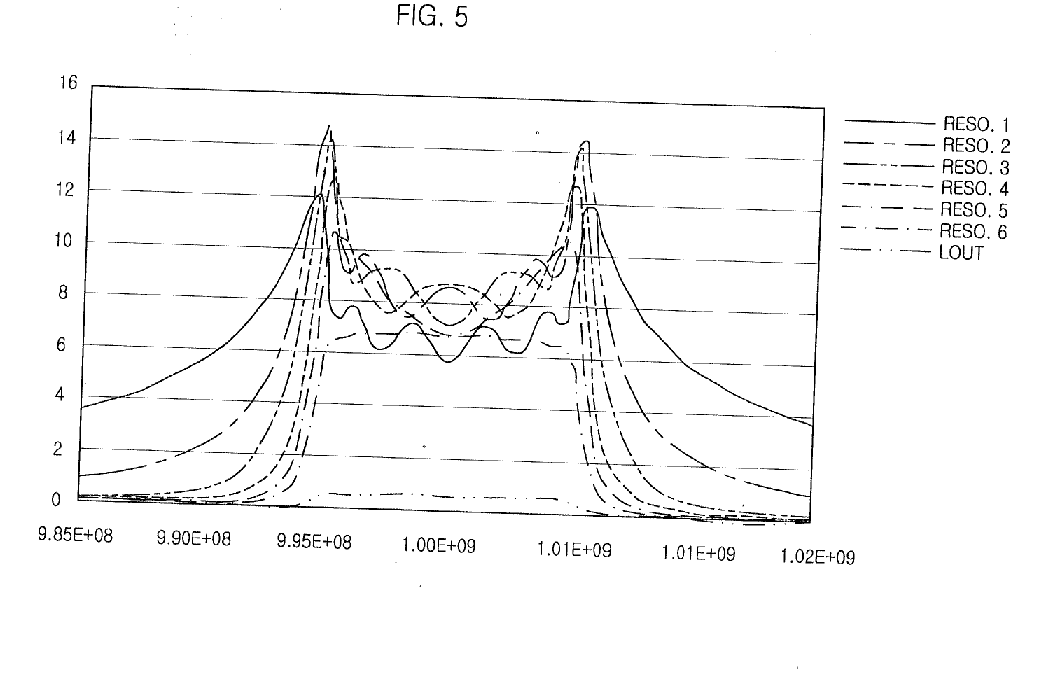

In FIG. 5, there is provided a graph describing amplitudes of current flowing through an output load of 50 Ω and each resonator according to a varying frequency when designing each resonator for use in an inventive filter to have an inside diameter of 10 mm and an outside diameter of 30 mm in accordance with an embodiment of the present invention.

As shown in FIG. 5, the peak current values of the first to the fifth resonators are found at the cut-off frequency of the filter and the sixth resonator shows a current characteristic similar to that of the filter. Moreover, it is realized that a resonator having the highest current value is the second resonator and the third resonator has the second highest current value.

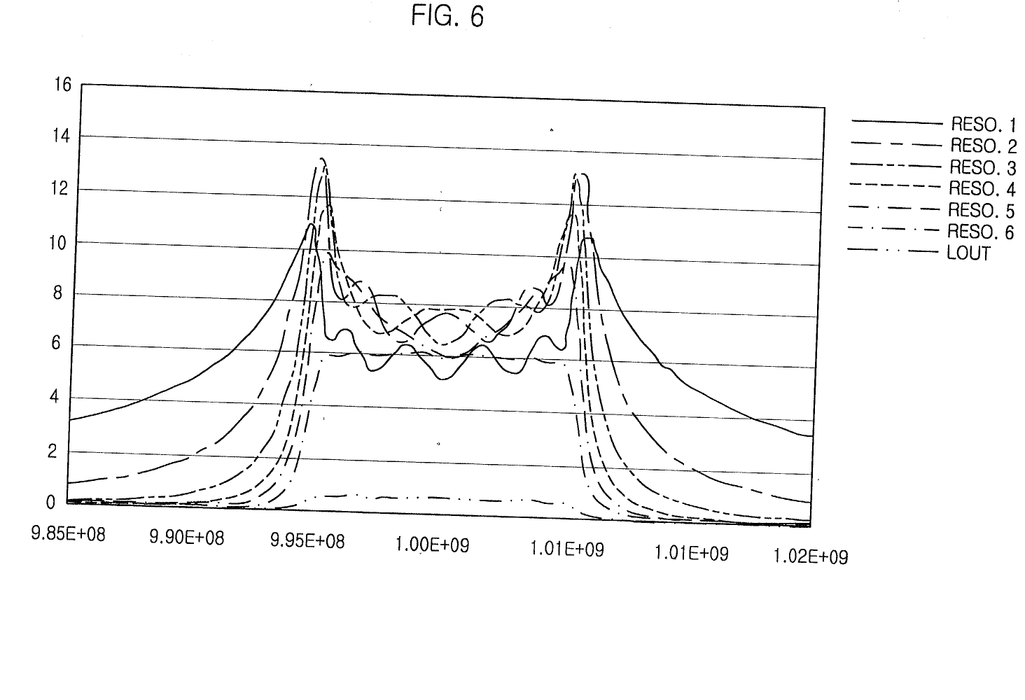

Referring to FIG. 6, there is represented a graph describing amplitudes of current flowing through an output load of 50 Ω and each resonator according to a varying frequency when designing each resonator for use in the inventive filter to have an inside diameter of 10 mm and an outside diameter of 40 mm in accordance with an embodiment of the present invention.

In FIG. 6, the peak current values of the first to the fifth resonators are detected at the cut-off frequency of the filter and the sixth resonator has a current characteristic similar to that of the filter. As can be seen from FIG. 6, it is noticed that a resonator having the highest current value is the second resonator and the third resonator has the second highest current value.

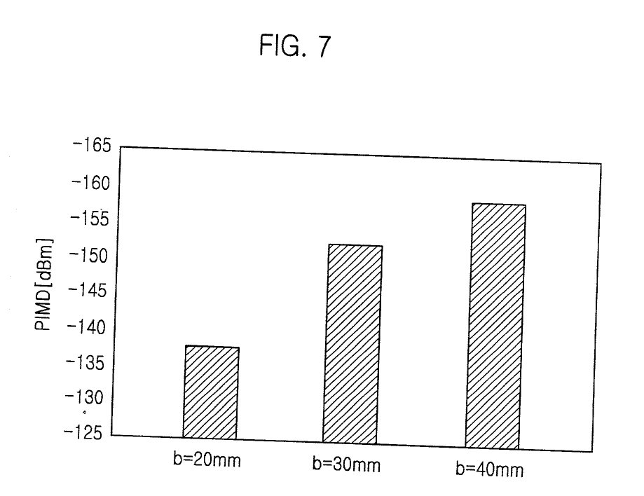

Referring to FIG. 7, there is a graph showing levels of final intermodulation distortion for the outside diameter of the resonator in accordance with the present invention. In the drawing, it turns out that the level of the intermodulation distortion decreases by about 21 dB as the outside diameter increases from 20 mm to 40 mm.

When transmitting signals through a general coaxial cable, there occurs a conductive loss by conductivity limited on the coaxial cable and this conductive loss is conducted as heat, which becomes a cause inducing new intermodulation distortion.

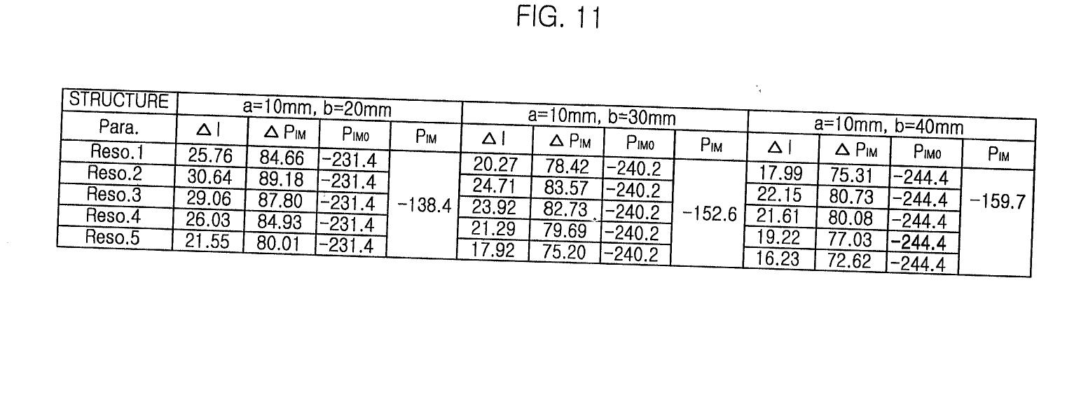

Based on this knowledge, there are computed the levels of the intermodulation distortion according to an amount of current of each resonator in the filter structures determined by considering FIG. 4, FIG. 5 and FIG. 6. The computing procedure is shown in FIG. 11.

In the computing procedure, ΔI represents a ratio of current flowing through the coaxial cable to current flowing through each resonator and ΔP_{IM} means an increased amount (dB) of intermodulation distortion caused by the increased amount of current.

P_{IMO} shows a level of intermodulation distortion induced by the current flowing through the coaxial cable.

Final P_{IM} is obtained by summing up P_{IMO} and ΔP_{IM}.

As described above, the interpretation of the intermodulation distortion of the filter is accomplished by finding the amplitude of current flowing through each resonator and, at the same time, it is noted that an amount of current flowing through each resonator should be minimized when trying to get a lower level of the intermodulation distortion in the filter design.

As one trial to implement the above purpose, it is advantageous to enlarge the characteristic impedance value Z₀ of each resonator, and to use dielectrics having a small dielectric constant between internal and external conductors or to utilize no dielectric therebetween. Further, it is important to design the inductance of each resonator to have a large value.

In accordance with the present invention, Z₀ of the present invention has a value between 65 Ω and 79 Ω while Z₀ is about 65 Ω when using the conventional 1:3 ratio of an inside diameter to an outside diameter.

Moreover, the inductance of each resonator is determined to have a larger value than that of the conventional resonator.

Since there is just enough space at a part where current is dense in each resonator to become the nonlinearity increased, it is advantageous not to use a tuning pole having a screw type for tuning and there is required a process for eliminating a non-contiguous point at the current dense part.

The following optimized result can be obtained when designing a filter for use in a base station of mobile communication systems such as IMT-2000 by employing the above-mentioned technique.

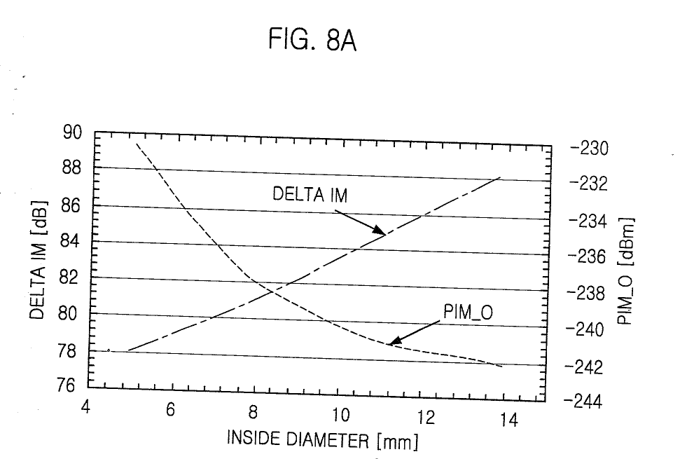

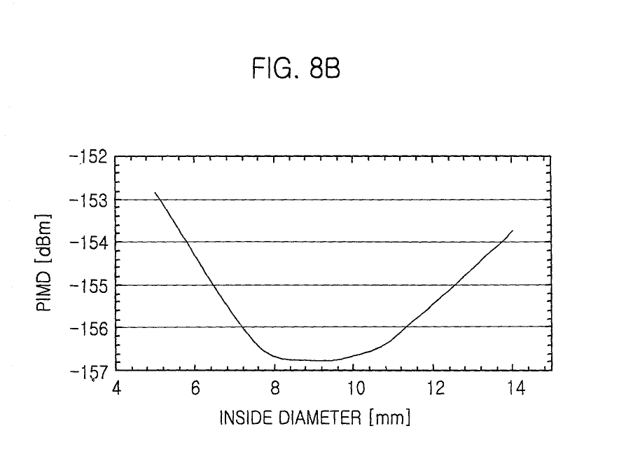

FIGS. 8A and 8B provide views showing the inside diameter capable of minimizing the intermodulation distortion when the outside diameter of each resonator is determined in accordance with the present invention.

Referring to FIG. 8A, there is shown a graph representing variation of the amplitude of initial intermodulation distortion and that of ascending intermodulation distortion in accordance with an embodiment of the present invention.

In the drawing, PIM_{—}0 represents the amplitude of the initial intermodulation distortion caused in the coaxial resonator structure and Delta IM shows the amplitude of the intermodulation distortion ascended by an increased current effect in the coaxial resonator structure.

In FIG. 8B, there is provided a graph displaying levels of final intermodulation distortion determined by adjusting the inside diameter in accordance with the present invention.

When the outside diameter is fixed as follows, the inside diameter will be optimized as shown herein below.

If the outside diameter b is set to 30 mm, the inside diameter a is optimized to a range of 8 mm to 10 mm. On the other hand, if the outside diameter b is 25 mm, the inside diameter a becomes 6.7 mm to 8.3 mm.

Further, if the outside diameter b is 20 mm, the inside diameter a is determined as 5.3 mm to 6.6 mm.

With reference to the inside and the outside diameters, it is noticed that the intermodulation distortion can be further reduced when determining the outside diameter three times larger than the inside diameter. In particular, it turns out that an excellent characteristic is acquired when the diameter ratio belongs to a range which is larger than 1:3 and smaller than or equal to 1:3.75.

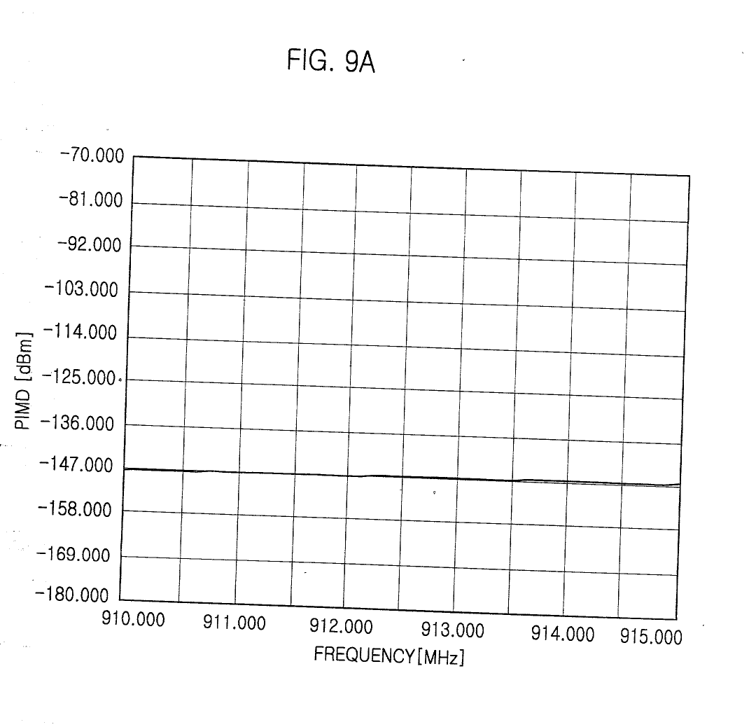

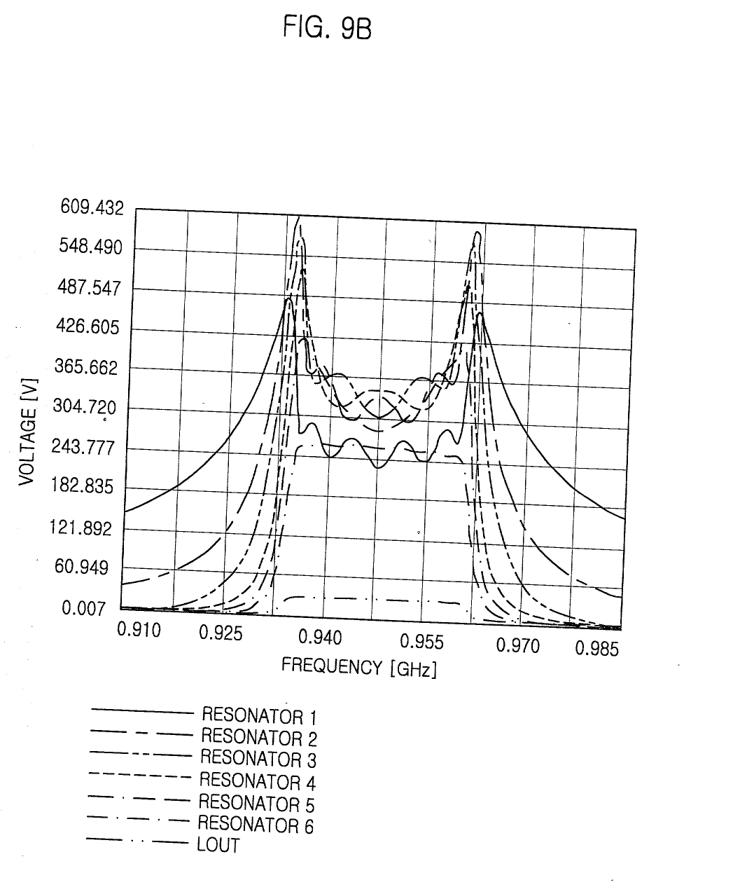

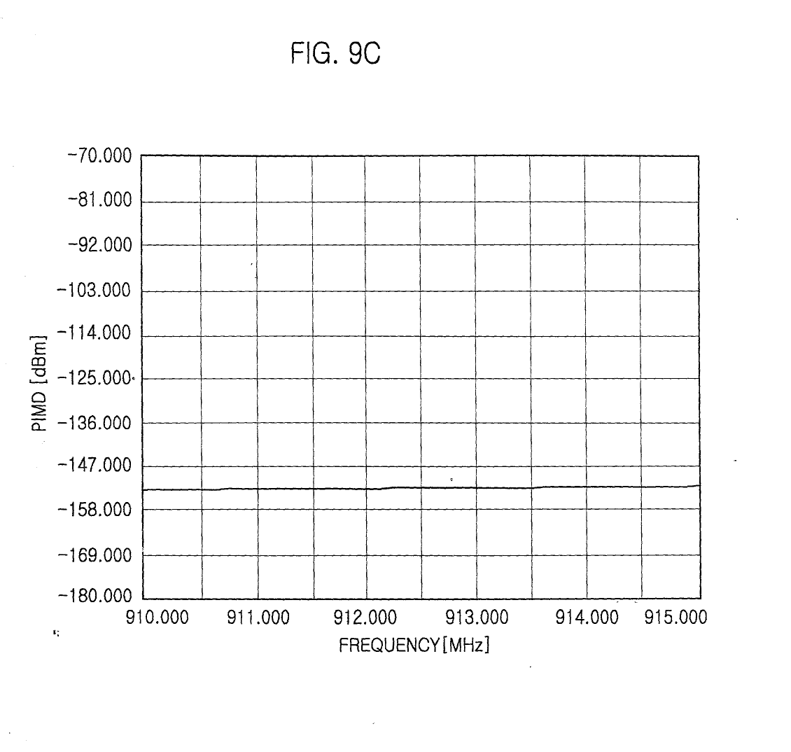

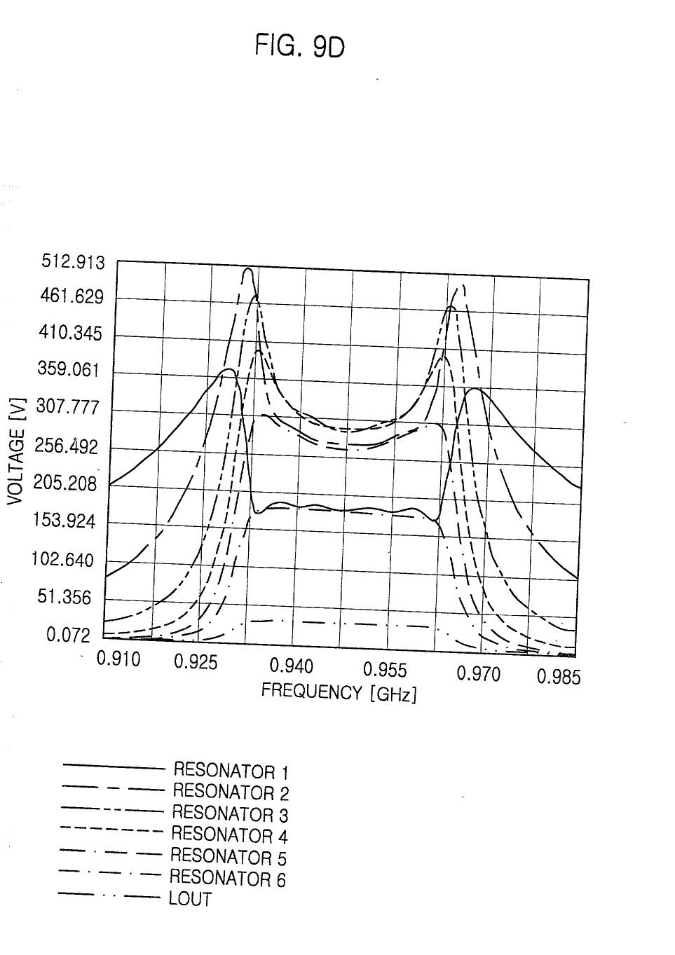

Referring to FIGS. 9A to 9D, there are shown views explaining the intermodulation distortion (PIMD) characteristic and voltage according to coupling between resonators that determines a ripple in a pass band of the filter when designing the resonator in accordance with the present invention.

FIG. 9A shows a graph describing the intermodulation distortion characteristic when deciding a ripple in a pass band as 0.1 dB and FIG. 9B provides a graph showing a voltage size detected at each resonator in case of FIG. 9A.

FIG. 9C presents a graph illustrating the intermodulation distortion characteristic when determining a ripple in a pass band as 0.001 dB and FIG. 9D depicts a graph displaying a voltage size detected at each resonator in case of FIG. 9C.

As shown in the drawings, when designing the ripple to have a smaller value, i.e., increasing the coupling between the resonators, it is noted that the reducing characteristic at a low pass band may be deteriorated while the level of the intermodulation distortion (PIMD) decreases.

Of course, it is well known to those skilled in the art that the inventive design technique considering both the circuit and the structure can be used together with the conventional local and minute processing technique.

As illustrated above, in accordance with the present invention, a design considering the intermodulation distortion can be performed at an initial step of the design, so that it is possible to obtain an effect of reducing the intermodulation distortion by analyzing the intermodulation distortion caused in the filter structure.

Further, in accordance with the present invention, by reducing the intermodulation distortion caused when performing the mobile communication, it is possible to solve the interference problem of the mobile communication system, increase the communication capacity, and improve the speech quality.

Also, the inventive filter manufacturing method can effectively produce filters by employing a circuitry and structural approach when designing the filters with breaking from the conventional approach depending on the minute processing step when manufacturing the filters.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A resonator for use in a filter, comprising a cylinder which has a ratio of an inside diameter to an outside diameter belonging to a range which is larger than about 1:3 and smaller than or equal to about 1:3.75 and whose length (H) is about λ/4, wherein λ is a wavelength of a plane wave provided to the resonator.

2. The resonator as recited in claim 11 wherein the resonator has the inside diameter belonging to a range which is larger than about 8 mm and smaller than or equal to about 10 mm when the outside diameter is determined as about 30 mm.

3. The resonator as recited in claim 1, wherein the resonator has the inside diameter belonging to a range which is larger than about 6.7 mm and smaller than or equal to about 8.3 mm when the outside diameter is decided as about 25 mm.

4. The resonator as recited in claim 1, wherein the resonator has the inside diameter belonging to a range which is larger than about 5.3 mm and smaller than or equal to about 6.6 mm when the outside diameter is set to about 20 mm.

5. A method for manufacturing a resonator filter to minimize the current flowing through each resonator constructing the resonator filter made of several resonators, which makes characteristic impedance of an equivalent circuit of the resonator filter having a value in a range which is larger than about 65 Ω and smaller than or equal to about 79 Ω.

6. The method according to claim 5, wherein inductance of the equivalent circuit is determined according to the characteristic impedance as follows:
$$L = \frac{4}{π {Y}_{0} {ω}_{0}}$$
wherein ω₀ represents a resonant frequency of the resonator filter.

7. The method according to claim 5 further employing a small ripple in order to increase the coupling between the resonators of the equivalent circuit.

8. A resonator filter manufactured by the method of claim 5.
